(19) United States
(12) Patent Application Publication
(10) Pub. No.: US 2008/0217160 A1
(43) Pub. Date: Sep. 11, 2008

(54) Sonochemistry

(76) Inventors: Amanda Barclay Gallaher, Dorset (GB); Dominic Bryan Hannon, Dorset (GB); David John Webster Hardie, Dorset (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/585,805

(22) PCT Filed: Jan. 14, 2005
(86) PCT No.: PCT/GB05/00109

§ 371 Date: Jul. 12, 2006

(30) Foreign Application Priority Data
Jan. 17, 2004 (GB) 0401050.0

(51) Int. Cl. B01J 19/10

(52) U.S. Cl. 204/157.15; 422/127

(57) ABSTRACT

A sonochemical reactor provides an environment for processing chemicals, waste products and the like. The reactor utilises a closely packed transducer arrangement. The transducer spacing is such that cross-coupling enhances the insonification region of fluid within the reaction chamber whilst avoiding undesirable longitudinal modes. The arrangement is particularly suited to continuous flow operation.

### FIELD OF THE INVENTION

The present invention relates to a sonochemistry reactor and methods of operation thereof.

### BACKGROUND TO THE INVENTION

Sonochemistry is the use of high intensity acoustic fields to enhance chemical reactions. High-frequency acoustic pressure variations literally tear water apart in the process known as cavitation. When the bubbles formed in the strongly cavitating water of a sonochemistry reactor collapse, very high local temperatures and pressures occur, and extremely reactive free radicals are generated.

For some years chemists have been able to demonstrate that the phenomenon of acoustic cavitation greatly enhances many useful chemical reactions performed in the laboratory. However, to date, the sonochemistry community has mainly consisted of chemists with recognised expertise in the chemistry of the process and the key to harnessing sonochemistry, which has so far proved elusive, is to scale it up to a practical size.

So far, industry attempts to scale up the sonochemistry process have only proved partially successful. Acoustic transmitter design has been sub-optimal and inefficient, leading to unduly high power consumption and involving unacceptable levels of equipment damage requiring costly replacement and overhaul.

### SUMMARY OF THE INVENTION

According to one aspect of the invention, there is provided a sonochemical reactor comprising a reaction chamber having a plurality of externally mounted transducers physically coupled thereto, the transducers being spaced apart along a longitudinal axis of the chamber wherein the transducers are operable in a breathing mode. That is, a mode in which the radial excitations of the chamber wall in contact with the transducers are in phase around the circumference of the vessel. The substantially uniform radial excitation ensures that input energy is focussed near the centre of the reaction chamber, and away from the reaction chamber walls. This leads to most of the input energy being transferred to the central half of the chamber volume. The intensity of the resulting cavitation is determined by the input power.

Preferably, the reactor chamber has an inlet and an outlet. These are advantageously arranged to be at opposite ends of the longitudinal axis. By providing for flow through the chamber, the reactor may be operated in a continuous mode. Whilst a batch mode of operation may suit those applications where a predetermined quantity of fluid is to be treated, such as in some applications in the chemical and pharmaceutical industries, a continuous operation mode is particularly suitable for those applications exemplified, in the case of the water industry, by water purification, sewage sludge processing and ground water remediation and in another application area such as the food industry, by sterilisation and emulsification operations. Other applications include industrial effluent processing, chemical/pharmaceutical processing (including nucleation—the “seeding” of crystals), and even hydrocarbon “cracking” and dispersal of nano-particles in fluid.

By adopting a spaced apart arrangement, in which preferably the transducers are arranged such that they each lie in a respective plane perpendicular to the longitudinal axis of the reaction chamber, the contribution to a cavitation region or insonified region within the reaction chamber is focussed along the longitudinal axis of the chamber and kept apart from the fluid interface with the chamber. At the same time, undesirable longitudinal vibration modes are minimised. In a preferred embodiment, the transducers are closely packed having a separation much less than the half wavelength separation commonly adopted in prior art reactors. Clearly, in the preferred embodiment of the invention where fluid may flow continuously in the direction of the longitudinal axis between the inlet and outlets to the reaction chamber, then the insonified region may extend along the flow axis corresponding to the longitudinal axis of the chamber. The spacing between rings is also preferably less that the diameter of the reaction chamber.

In one embodiment of the invention, the reaction chamber is in the form of a thin-wall right circular cylinder. Such a configuration facilitates excitation of the transducers to excite the reaction chamber into a breathing mode of operation. Furthermore, it allow straightforward positioning and attachment of the transducers to the chamber. In addition, it may allow the reaction chamber to be removed from the other structure of the reactor to permit cleaning, repair or replacement of the reaction chamber to be exercised. Whilst a thin-walled right circular cylinder is favoured for the reasons just given, other configurations may be adopted including, but not limited to, toroids. In some embodiments each transducer may be provided as a unitary device which can be slid over the reaction chamber and fixed in position. Alternatively, each transducer may be assembled from a set of elements which each can be fixed to the chamber so as to form a ring transducer in situ on the reaction chamber. The latter approach is particularly favoured when the diameter of the reaction chamber is larger as the availability of unitary ring transducers above a diameter of around 10 cm is currently quite limited. In either case it has been recognised that the eccentricity of the reaction chamber should be as close as possible to zero so as to ensure the transducer can be mounted with its entire extent in circumferential contact with the reaction chamber. Substantially full circumferential contact between the reaction chamber and an active face of each transducer ensures that the reaction chamber is driven into resonance in a breathing mode rather than the longitudinal mode that may exist where the communication between the active face and the reaction chamber is discrete much as would be the case if a set of, for example, piston-driven point resonators were placed in contact with the reaction chamber around a circumference thereof. The presence of just such a longitudinal mode is clearly detrimental when attempting to insonify fluid within the region identified above. In addition it will be recognised that simply increasing the length of the reaction chamber and number of transducers without any alteration in diameter of the reaction chamber allows a straightforward scale up of power delivery and hence capacity of the reactor.

By focusing the insonification in the above described regions, it is possible to minimise the potential for cavitation occurring other than around the longitudinal axis of the reaction chamber. Furthermore, by placing the transducers outside the reaction chamber, the potential for any cavitation damage, or indeed damage resulting from the fluid itself, is avoided. A still further advantage of having the transducers outside the fluid is that it simplifies the delivery of electrical power. Whilst steps may be taken to protect the power supply to transducers within a reaction chamber of the prior art, the risk in such an arrangement can never be completely removed of an accidental short circuit or discharge. Again, in certain applications where the fluid is an explosion risk or its release could not otherwise be tolerated, there are clear disadvantages to an approach which does not, as in the present invention, seek to isolate the electrical supply from the reaction chamber and its contents

Whilst the prior art would appear to suggest that a spacing of the order of half the wavelength of the operating frequency of the transducers would be effective it has been somewhat surprisingly found that a spacing in the region of a quarter of the wavelength of the operating frequency of the transducers is particularly effective in one particular embodiment. Indeed, it is believed that the most effective coupling of the transducers to the reaction chamber and hence the most efficient transfer of energy into the insonified fluid occurs when the transducers are separated by the smallest practical non-zero amount, which could be less than a quarter wavelength, to prevent coupling between each of them as would be the case if the individual transducers were all replaced by a columnar transducer. This latter form of transducer would almost certainly result in the reaction chamber being driven in a longitudinal mode.

It is also preferred that transducers be driven in phase with each other along the length of the reaction chamber.

The specific frequency for driving the transducers varies with the dimensions and construction of the reaction chamber, and the nature of the material flowing in it, but may be determined empirically for specific embodiments.

As has been just indicated, the spacing between the transducers is preferably such that the reaction chamber is driven into a breathing mode of resonance. Such a mode requires that the cross-section of the reaction chamber is symmetrical. Whilst conveniently radially poled ring transducers can be used to drive the reaction chamber into a breathing mode, a more effective electro-acoustic coupling can be obtained by utilising tangentially (or circumferentially) poled ring transducers. Again, as has been indicated, the ring transducers should be located as close together as can be achieved without cross-coupling occurring between them which could result in the reaction chamber being driven in a longitudinal mode.

By coupling the transducer to the chamber, it is driven into resonance by the transducers. It is believed that by directly driving the chamber into resonance and including the response and accurately modelling the structural response of the chamber that effective insonification can take place. In a preferred embodiment the reactor further includes a sleeve encompassing the reaction chamber. In this embodiment, the transducers are carried by the sleeve rather than directly by the reaction chamber. Although the foregoing comments regarding the positioning of the transducers on the reaction chamber apply directly to the positioning of the transducers on the sleeve in this embodiment, there are further advantages to such an arrangement as set out in detail below. Accordingly, there is defined between the sleeve and an outer surface of the chamber a space, filled with a suitably high viscosity fluid (for example oil), across which acoustic energy from the transducers carried by the sleeve is transmitted. Advantageously, such an arrangement provides protection against cavitation induced damage on the active faces of the transducers and also seeks to reduce the formation of a masking layer of cavitation proximate the transducers. The oil also provides damping which can minimise the effect of any undesirable longitudinal mode of vibration. Furthermore, rather than being enclosed, the oil space may communicate with an oil circuit cooling circuit such that oil may be pumped through the space and excess heat generated by the operation of the transducers and/or arising from the reaction chamber itself, is carried away from the reaction chamber. Furthermore, through selection of a suitable mounting, the reaction chamber may be removed from the sleeve without disturbing the transducers and any associated drive electronics. Thus, the reaction chamber may be swapped out for overhaul and/or maintenance operations. Preferably, whilst a higher-viscosity fluid (for example oil) is provided between the sleeve and the outer surface of the reaction chamber (the liquid being selected to maximise energy transfer to the chamber) it is also preferable that the transducers be backed by a lower viscosity fluid (for example air)so as to minimise outward energy dissipation. Other pairs of suitable fluids within and outside the sleeve will be apparent to the skilled person and may be determined empirically.

It will be recognised that the present invention seeks to overcome the maintenance and performance problems inherent in operating a reaction chamber with internally mounted transducers. In particular, the invention seeks to overcome the disadvantages inherent in seeking directly to cause excitation within the fluid. Accordingly, it has been recognised that the acoustic impedance of the fluid due to cavitation is significant, Where, as in the prior art, the transducers are driven so as to directly insonify the fluid the changes in acoustic impedance brought about by cavitation at or near the periphery of the chamber will alter the load on the transducer to the detriment of the effect being sought. The control of a transducer in such circumstances can be problematic. Secondly, where the fluid is non-homogenous there can be variations in the acoustic impedance of the fluid within the reaction chamber which may be periodic or non-periodic in nature. Such variations can also be detrimental to the control of a transducer which seeks to act insonify the fluid directly.

In the present invention, by focussing cavitation in the region of the chamber remote from the inner faces of the walls, the power dissipated in the central region may be high whilst maintaining or reducing power dissipation—and hence unwanted cavitation—proximate the walls and hence the transducers.

Furthermore, by causing cavitating in, and hence disturbing, the central bulk flow in the chamber, it is understood that stirring of the peripheral material back into the central cavitated region is also more likely.

Still preferably, a controller may be provided to control the operation of the reactor and in particular the amplitude and phase at which each transducer is driven. Whilst each transducer may be driven identically, it may be advantageous to drive each transducer selectively. Such selective drive could be used to compensate for changes in acoustic impedance or to sweep the region of insonification through the reaction chamber, for example. Furthermore, it should be noted that the operational frequency of a transducer is inversely proportional to its linear dimension whilst the drive field limited power radiated by a transducer is directly proportional to the square of the linear dimension. Thus, high pressure fields are more readily achieved and over a larger volume at lower frequencies. Conveniently, in order to ensure that the insonification field caters to mechanisms of reaction and breakdown supported by low and high frequency cavitation mechanism, said transducers may be selectably driven at both relatively high and low frequencies. In one particular embodiment, a low frequency transducer can be used to reduce the cavitation threshold for a less powerful but frequency agile high frequency transducer. Such an arrangement is particularly advantageous where reliance is made on reactions being triggered by particular cavitation mechanisms

In accordance with a further aspect of the invention, there is provided a sonochemical processing system including at least one reactor according to said first aspect, the system further including a holding tank connected to an inlet of said reactor and a collection tank connected to said outlet

Preferably, a plurality of reactors may be provided within a flow path connecting the holding and collection tanks. Conveniently, a manifold may provide for distribution of fluid to one or more reactors. In which case, a set of valves may be inserted in the flow path so as to permit the isolation of one or more reactors for servicing and/or repair operations. Conveniently, the operation of the valves may be under the control of a controller. The controller may operate in accordance with a set of instructions which could be varied by an operator either manually and/or automatically in response to a change in the physical and/or operating characteristics of the system.

Again preferably, the flow path may permit the re-circulation of fluid through the reactor or reactors. This is particularly advantageous in those applications where a single pass through the reactor may not bring about the required changes in the fluid.

The invention is also directed to methods by which the apparatus and systems operate and including method steps corresponding to the component parts by which the apparatus and systems operate.

In particular, according to a further aspect of the present invention there is provided a method of insonofying a fluid, the method comprising the steps of: providing a reaction chamber having a plurality of externally mounted transducers physically coupled thereto, the transducers being spaced apart along a longitudinal axis of the chamber; locating the fluid in the reaction chamber; operating the transducers so as to excite the reaction chamber walls in a breathing mode.

The invention is also directed to programs for computers arranged to implement or operate the apparatus. In this context programs are intended to include hardwired programs, firmware, and software, and also includes software intended to be compiled to chip designs or other hardware layouts used in the invention.

In particular, according to another aspect of the present invention there is provided a program for a computer arranged to operate the apparatus in a breathing mode. This would typically form part of a controller for the apparatus.

The preferred features may be combined with any of the aspects of the invention as would be apparent to the person skilled in the art.

### BRIEF DESCRIPTION OF THE FIGURES

In order to assist in understanding the invention, a particular embodiment thereof will now be described, by way of example and with reference to the accompanying drawings, in which:

FIG. 1, is a schematic plan view of a fluid processing system including a sonochemical reactor of the invention;

FIG. 2, is a side view of a reactor of FIG. 1;

FIG. 3 is a cross-sectional side of the reactor of FIG. 2; and

FIG. 4 is an end view of the reactor of FIG. 2.

### DETAILED DESCRIPTION OF THE INVENTION

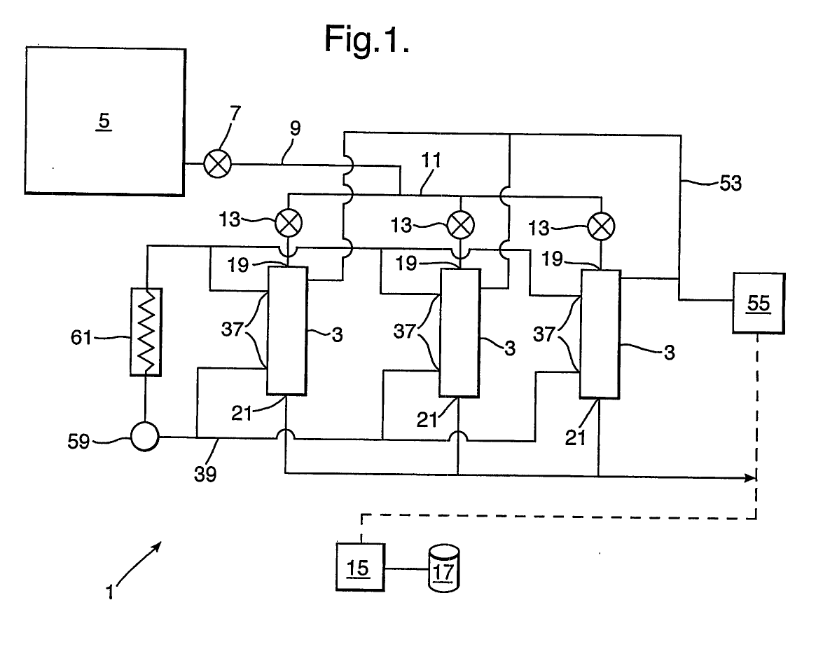

Referring to the FIG. 1, there is shown a fluid processing system 1 incorporating a set of sonochemical reactors 3 (hereinafter referred to individually as a reactor). The system 1 has a holding tank 5 for receiving fluid delivered by tanker (not shown). In a non-illustrated variant, rather than having a holding tank, the system has a direct connection to a source of fluid which could be a waste stream from an adjacent facility. The holding tank 5 is connected via a solenoid operated control valve 7 to a feed pipe 9 which connects to a manifold 11 that supplies the set of three reactors 3 via respective further solenoid operated isolation valves 13. The valves 7, 13 are operated electrically in response to impulses received from a controller 15. The controller is operated in response to a set of software instructions held in a memory store 17. The store 17 may be updated with various sets of instructions depending on the particular configuration of the system 1.

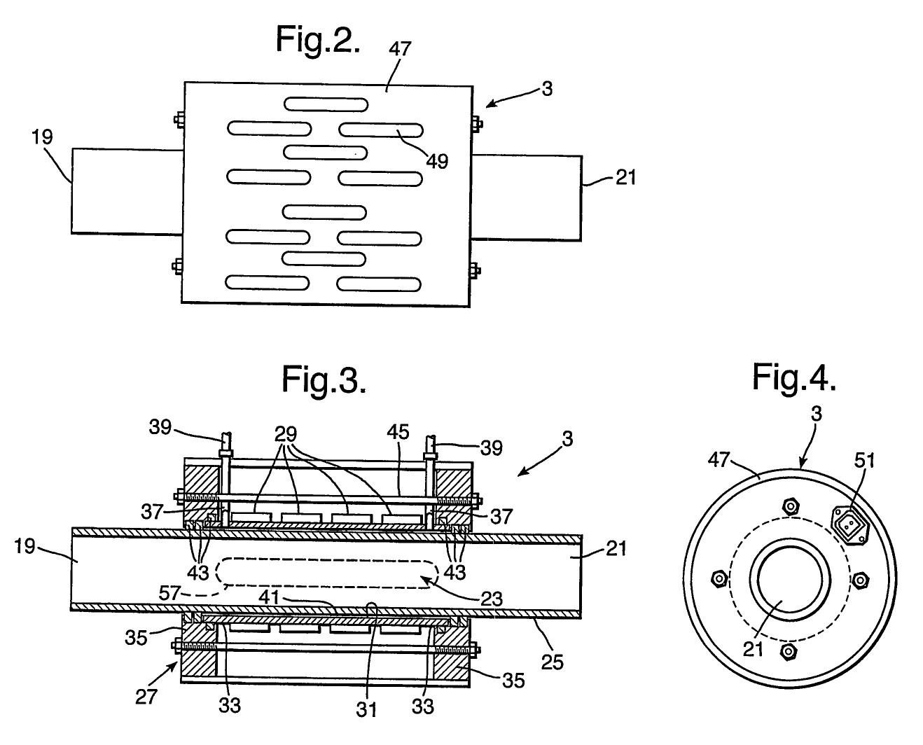

Turning to the reactors 3 and with reference to FIGS. 2, 3 and 4, each is mounted substantially vertically in a stand with an inlet 19 located above an outlet 21 such that gravity assists in the flow of fluid through a reaction chamber 23 in the form of a hollow steel right circular cylinder 25. The inlet 19 to the reaction chamber 23 is sized so as to be larger in cross-section than the feed from the manifold 11. In use, such an abrupt increase in cross-sectional area brings about a reduction in pressure in the fluid passing into the reaction chamber 23. A reduction of pressure is useful in facilitating the onset of cavitation.

The cylinder 25 is encompassed by an excitation assembly 27 incorporating a set of four ring transducers 29. The ring transducers 29 are arranged in a stacked and spaced apart configuration. Together the cylinder 25 and assembly 27 make up the reactor structure. The transducers 29 are an interference fit over a cylindrical sleeve 31 whose internal diameter is larger than the outside diameter of the cylinder 25. Free ends 33 of the sleeve are received in respective end caps 35 so as to maintain the sleeve 31 and cylinder 25 in a spaced apart relationship.

The sleeve 31 is provided with a pair of tappings 37 which provide connections to an oil circuit 39 whose volume includes the oil space 47 bounded by the outer surface of the cylinder 25 chamber, the inner surface of the sleeve 31 and two sets of three O-ring seals 43 disposed at each free end 33 of the sleeve 31. The sets of seals are retained against the sleeve and reaction chamber by the respective end caps 35. Thus, a first o-ring 43 is seated between the end cap 35 and the sleeve 31, a further two o-rings 43 form a seal between the cylinder 25 and the end cap 35. The end caps 35 are themselves tensioned by a set of four bolts 45. A cylindrical shroud 47 provided with a plurality of ventilation slots 49 encloses the excitation assembly 27.

One of the end 35 caps includes a recess in which is secured an electrical socket 51 for a power supply used to drive the transducers 29. Internal electrical connections (not shown) are made between the transducers 29 and the electrical socket 51. A power cord 53 transfers electrical power from a controller (for example a drive circuit or software programmed controller) 55 to the, socket for onward transmission to the transducers 29.

The transducers 29 are segmented radially excited elements which when excited operate in an extensional or breathing mode. In use, the excitation is coupled closely to the sleeve 31 and via oil space 41 to the reaction chamber 23 itself such that the transducers 29 are used to drive the structure into resonance, this resonance of the structure is used to create a volume of cavitation or region 57 (shown banked in broken line) within the fluid. The transducers 29 are all driven in phase although in one variant of the present embodiment the phase relationship between the transducers 29 may be varied. Furthermore, rather than drive all the transducers 29 at substantially similar frequencies, the drive frequencies may be selected so that at least some are in a relatively higher frequency range than the remainder. By so doing, it is believed that a more effective reaction environment might be created within the reaction chamber 23.

In a further variant of the embodiment, rather than driving all the transducer elements 29 in phase at equal amplitude or even at similar frequencies, the controller 55 is capable of driving each transducer in differing phase and amplitude. Consequently, it is possible through appropriate selection of amplitude and phase to generate dynamically a particular insonification field, via the resonance generated in the structure, throughout the volume of the reaction chamber 23. It will be apparent that the field may be varied over time and that this permits the creation of a moving volume of cavitation 57 to be created within the reaction chamber 23. This volume 57 may be swept or scanned through the volume of the reaction chamber 23 and may track or indeed lag or lead the body of flow of fluid through the chamber 23. In addition to providing for dynamic variation in the insonification field within the reactor 3, the transducers 29 themselves may be equipped with load monitoring circuitry (not shown). The circuitry is intended to provide an indication of the acoustic impedance of the fluid passing through the reaction chamber 23 during use. Any variation in load on a transducer as a result of a changed impedance can be monitored and through suitable processing the feedback obtained may be utilised in a closed loop feedback control mechanism to adjust the parameters of the transducer 29 driving controller 55 to ensure maximum cavitation efficiency, for example

To guard against overheating of the transducers 29, oil is circulated through the oil space 41 via a pump 59 and oil cooler 61 located remotely of the reactor 3. The slots 49 in the shroud 47 further assist in cooling as they allow air, which may be forced, to circulate through the volume of the excitation assembly 27.

In use, the controller 15 causes the control valve 7 to open allowing fluid to pass from the holding tank 5 via the feed pipe 9 into the manifold 11. The controller 15 further opens one or more of the isolation valves 13 allowing the fluid to pass into respective reactors 3. In the event of the breakdown or servicing of a reactor 3, the controller 15 will signal the respective manifold isolation valve 13 to close, thereby isolating the reactor 3 from the fluid delivery circuit.

Whilst the fluid is being delivered to each reactor 3, the controller 15 generates the relevant control signals necessary to supply electrical power to the transducers 29. The transducers 29 are thus excited in a radial breathing mode at a selected frequency and amplitude. The excitation of the transducers 29 is controlled by the feedback circuit to ensure that their output remains within a desired range. In a particular variant of the embodiment, the controller 15 is able to control the transducers independently via the controller 55.

As the fluid passes into the reaction chamber 23 it encounters a region 57 in which cavitation is developed and whilst in this region, the energy supplied to the fluid brings about reactions which assist in breaking down the products within the fluid. The region 57 is effectively focussed by the stacked spaced apart arrangement of the transducers 29 to ensure that the region 57 extends along the direction of flow of the fluid whilst avoiding any incidence of the legion 57 on the internal surface of the cylinder 25.

Subsequently, the treated fluid leaves the reactor 3 via the outlet 21 into a pipe which supplies a collecting tank (not shown).

It will be appreciated that the system, reactor and method described above in relation to the treatment of fluid is applicable to a large range of applications as exemplified by the following non-exhaustive list. Accordingly, the invention may be utilised in the water industry for water purification, sewage sludge treatment and ground water remediation; it may be employed in the food industry in sterilisation and emulsification; it may be used in disposal and decontamination of chemical and biological weapons; it may be utilised in the chemical, pharmaceutical and general industry in the improvement of yields, replacement of catalysts, reduction in solvents, breaking down of long chain polymers and so-called ‘green chemistry’; it may be utilised in nuclear waste reprocessing and ship ballast water cleaning and finally it could find applications in the leisure market such as, for example in the disinfecting of bathing pools.

1. A sonochemical reactor comprising a reaction chamber having a plurality of externally mounted transducers physically coupled thereto, the transducers being spaced apart along a longitudinal axis of the chamber and in which the transducers are operable to excite the reaction chamber walls in a breathing mode.

2. A sonochemical reactor according to claim 1 in which cavitation is induced within the reaction chamber predominantly in a central region remote from the reaction chamber wall.

3. A reactor as claimed in claim 1, in which each said transducer is a ring transducer.

4. A reactor as claimed in claim 2, in which the transducer is radially poled.

5. A reactor as claimed in claim 2 in which the transducer is tangentially poled.

6. A reactor as claimed in claim 1, in which the transducers are spaced apart by a distance of substantially one quarter or less of the wavelength of their excitation frequency.

7. A reactor as claimed in claim 1, in which each transducer lies substantially within a respective plane orthogonal to said longitudinal axis.

8. A reactor as claimed in claim 1, in which the reaction chamber is a thin-walled right circular cylinder.

9. A reactor as claimed in claim 1, in which the reaction chamber is oil-cooled.

10. A reactor according to claim 1 in which the transducers are driven in phase with each other.

11. A reactor according to claim 1 further comprising a sleeve disposed around the reaction chamber, the transducers being mounted on an outer face of the sleeve and the volume between the sleeve and the reaction chamber containing a first fluid of a viscosity higher than a second fluid around the transducers.

12. A reactor according to claim 11 in which the first fluid is oil.

13. A reactor according to claim 11 in which the second fluid is air.

14. A reactor according to claim 11 in which one or more of the first and second fluids is circulated to provide a cooling effect.

15. A reactor as claimed in claim 1, in which a separate inlet and outlet is provided to the reaction chamber.

16. A controller for a reactor as claimed in claim 1, the controller being arranged to operate the transducers in a breathing mode.

17. A sonochemical processing system including at least one reactor as claimed in claim 1, the system further including a holding tank connected to an inlet of said reactor and a collection tank connected to said outlet.

18. A system as claimed in claim 17, further including a manifold connecting said holding tank to a plurality of reactors.

19. A method of insonofying a fluid, the method comprising the steps of:
providing a reaction chamber having a plurality of externally mounted transducers physically coupled thereto, the transducers being spaced apart along a longitudinal axis of the chamber;
locating the fluid in the reaction chamber; and
operating the transducers so as to excite the reaction chamber walls in a breathing mode.

20. A method according to claim 19 in which the fluid is one of waste sludge, industrial effluent, a chemical or pharmaceutical compound, a hydrocarbon, and a food product or component.

21. A program for a computer for operating sonochemical reactor comprising a reaction chamber having a plurality of externally mounted transducers physically coupled thereto, the transducers being spaced apart along a longitudinal axis of the chamber, the program having code portions arranged to operate the transducers so as to excite the reaction chamber walls in a breathing mode.
